(19) United States
(12) Patent Application Publication
(10) Pub. No.: US 2021/0106851 A1
(43) Pub. Date: Apr. 15, 2021

(54) FACE SEAL FOR A FULL-FACE MASK

(71) Applicant: 9293523 CANADA INC., BOUCHERVILLE (CA)

(72) Inventor: Felix COUTURE, BOUCHERVILLE (CA)

(21) Appl. No.: 16/598,603

(22) Filed: Oct. 10, 2019

(51) Int. Cl. A62B 18/02; A42B 3/04; A62B 18/08

(52) U.S. Cl. CPC A62B 18/02; A62B 18/084; A42B 3/0406

(57) ABSTRACT

A face seal for a full-face mask includes a sealing element for sealingly contacting at least a part of a face of a user, and a cradle. The sealing element have a peripheral portion and a forehead portion extending along at least a part of the peripheral portion. The cradle is provided on the peripheral portion and have a channel with an opening extending along the forehead portion. The opening is sized and shaped for receiving a head suspension harness of a hat abutting downwardly therein.

The present invention relates to face masks, and more particularly to a face seal for a full-face mask.

### BACKGROUND

Safety is nowadays a paramount issue in chemical plants, oil field rig sites, refineries or other industrial sites. Most plants and industrial sites require their employees to wear protective headgear such as safety or hard hat during work time, especially if they are working in a space-restricted environment where the risk of head injuries is increased. In confined or enclosed hazardous working space in presence of toxic or dangerous airborne contaminants, such as gases, fumes and/or air particles, employees are also required to wear additional piece(s) of protective equipment.

One such pieces of protective equipment are face masks, such as full-face masks integrating a lens and a respirator to protect critical and sensitive organs, notably the eyes, the nose, and the lungs. These are also known as full-face mask respirators. To offer optimal protection to a user, full-face masks must maintain a properly sealed contact with the user's face, including notably the eyes, nose, and mouth.

However, the combined wearing of a safety hat with a full-face mask usually compromises or breaks the sealed contact between the full-face mask and at least a part of the user's face, causing health and safety risk for the user. Indeed, component(s) of the safety hat, such as a head suspension harness used to maintain the safety hat onto the user's head, may physically interfere or hinder with the full-face mask, including a face seal thereof.

For example, either the head suspension harness of the safety hat may push down on the full-face mask or the full-face mask may push up on the safety hat. In all cases, a properly sealed contact between the face seal of the full-face mask and a part of the user's face, such as user's eyes, nose, and/or mouth, may not be maintained. Further, in the event where the safety hat receives a hit, because the suspension of the safety hat may contact with and push down the full-face mask, the face mask may be displaced in relation to the user's face, also disrupting the sealed contact between the full-face mask and the user's face.

Another shortcoming of wearing a safety hat and a full-face mask simultaneously comes from the discomfort associated with the physical interference and hindrance of the safety hat suspension with the full-face mask. Even in selecting independently the size of the safety hat and full-face mask, it still remains difficult to find a good fit between these two pieces of personal protective gear in function of the general head morphology of the user. This discomfort may cause the user to avoid wearing these pieces of personal protective gear when it is required for security reasons.

Therefore, there is a need for an improved face seal for a full-face mask an/or an improved full-face mask. The present invention addresses these needs and other needs as it will be apparent from review of the disclosure and description of the features of the invention hereinafter.

### SUMMARY

According to a first broad aspect, there is disclosed a face seal for a full-face mask, comprising:
a sealing element to sealingly contact at least a part of a face of a user, the sealing element having a peripheral portion and a forehead portion extending along at least a part of the peripheral portion; and
a cradle provided on the forehead portion, the cradle having a channel extending along at least a part of the forehead portion, the channel being sized and shaped to receive a head suspension harness of a hat therein.

According to a second broad aspect, there is disclosed a full-face mask, comprising:
a body having a peripheral portion and a forehead portion extending along at least a part of the peripheral portion; and
a cradle provided on the forehead portion, the cradle having a channel extending along at least a part of the forehead portion, the channel being sized and shaped to receive a head suspension harness of a hat therein.

According to a third broad aspect, there is disclosed a cradle for a full-face mask, the cradle being removably connectable to a forehead portion of a peripheral portion of the full-face mask, the cradle comprising a channel configured in sized and shaped to receive a head suspension harness of a hat therein.

In an embodiment, the cradle is substantially rigid.

In an embodiment, the cradle comprises two resiliently deformable element for contacting at least a part of a forehead of the use, further wherein one of the two resiliently deformable element sealingly contact the cradle to the at least a part of a forehead of the use.

In an embodiment, any one of the resiliently deformable elements is made of silicon, rubber, and foam.

In an embodiment, the cradle comprises at least one strap projecting thereof to adjust the full-face mask to the face of the user.

In an embodiment, the head suspension harness received in the cradle is fastened thereto by snap fit.

In an embodiment, the full-face mask is a full-face mask respirator.

In an embodiment, the hat is a security hat.

In an embodiment, the face seal is adapted to be retrofitted to a full-face mask.

In an embodiment, the full-face mask comprises the face seal as described herein.

### BRIEF DESCRIPTION OF THE DRAWINGS

Further features and advantages of the present invention will become apparent from the following detailed description, taken in combination with the appended drawings, in which:

FIG. 1 is a left side elevation view of a face seal for a full-face mask that is worn by a user simultaneously with a safety hat, in accordance with an embodiment;

FIG. 2 is another left side elevation view of the face seal for a full-face mask of FIG. 1 that is worn by a user without the safety hat;

FIG. 3 is an enlarged fragmentary view of the face seal for a full-face mask of FIG. 2;

FIG. 4A is a left side elevation and enlarged fragmentary view of a cradle of a face seal and a strap for a full-face mask, in accordance with an embodiment;

FIG. 4B is another left side elevation and enlarged fragmentary view of the cradle of the face seal for the full-face mask of FIG. 4A without a strap;

FIG. 5 is a left side elevation and enlarged fragmentary view of the face seal for the full-face mask of FIG. 1 where a head suspension harness of the hat is received into a cradle.

It will be noted that throughout the appended drawings, like features are identified by like reference numerals.

### DETAILED DESCRIPTION

In the following description of the embodiments, references to the accompanying drawings are by way of illustration of an example by which the invention may be practiced. It will be appreciated that other embodiments may be made without departing from the scope of the invention disclosed herein.

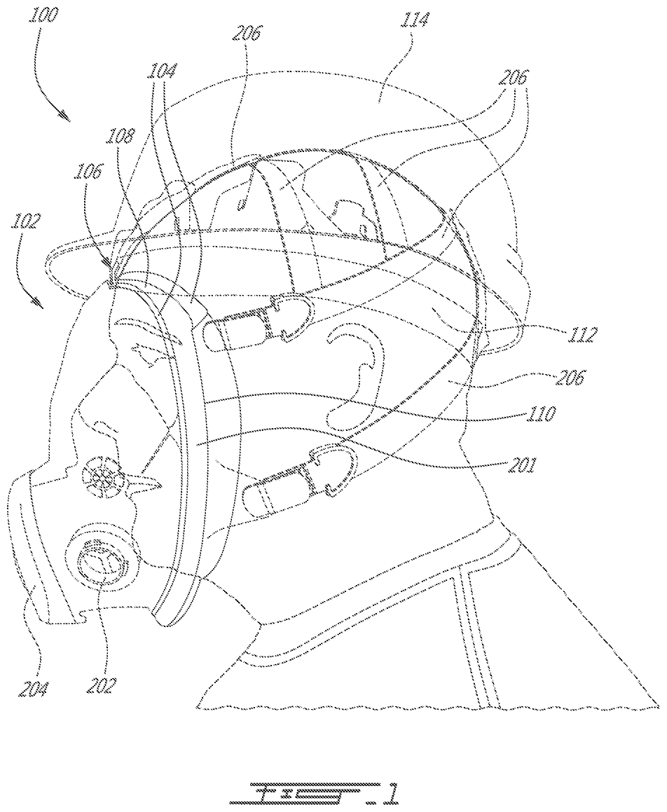

With reference to FIG. 1, there is described a face seal 100 for a full-face mask 102, according to an embodiment. The face seal 100 comprises a sealing element 104 and a cradle 106. The sealing element 104 is adapted to sealingly contact at least a part of the face of a user when the user wears the full-face mask 102. The sealing element 104 comprises a forehead portion 108 that is adapted to contact at least a part of a forehead of the user. The cradle 106 is provided on the forehead portion 108 of the sealing element 104 and extends along a peripheral portion 110 of the face seal 100. The cradle 106 is configured is sized and shaped to receive a head suspension harness 112 of a hat 114, such as a hard hat or a security hat, therein when the user wears the full-face mask 102 and the hat 114 simultaneously.

As it will become apparent hereinafter, the cradle 106 of the face seal 100 enables the user to wear the full-face mask 102 and the hat 114 simultaneously without compromising or breaking the sealed contact between the full-face mask 102 and at least a part of the face of the user.

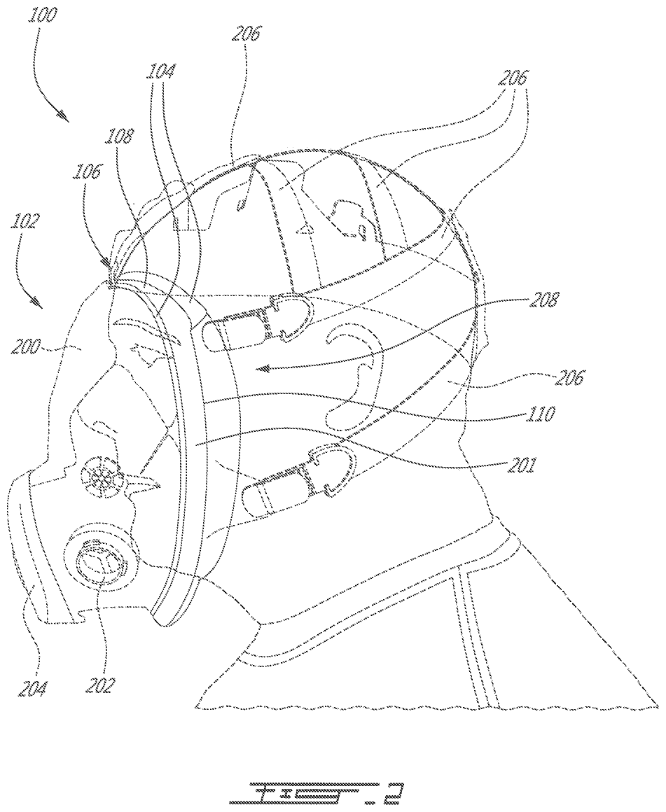

FIG. 2 illustrates the face seal 100 installed or mounted on the full-face mask 102, which is worn by the user in the absence of the hat 114 for the sake of clarity. The full-face mask 102 comprises a frame 201, a lens 200 for vision, at least one air intake valves 202 attachable to at least one cartridge air filter and at least one air output valve 204 to move air in and out of the full-face mask 102 as the user breathes, and a plurality of straps 206, such as pull-straps, to strap or attach the full-face mask 102 to the head of the user. The straps 206 are generally located along the peripheral portion 110 of the face seal 100, such as atop and on either side of the full-face mask 102, and project away therefrom. Alternatively, one or more strap(s) 206 may be provided on the frame 201 of the full-face mask 102 and extend therefrom. The full-face mask 102 has a general oval or round shape comprising a cavity 208, which is defined at least in part by the lens 200, for receiving at least a part of the face of the user therein. The cavity 208 is surrounded by the frame 201 and, when the face seal 201 is installed or mounted thereon, the peripheral portion 110 of the face seal 100. As such, the peripheral portion 110 of the face seal 100 extends along the frame 201 of the full-face mask 102. In this configuration, the sealing element 104 of the face seal 100 provides a proper sealing contact with the face of the user.

While the face seal 100 is installed on and used with the full-face mask 102, the skilled addressee will appreciate that any other full-face mask may be used with the face seal 100 without departing from the scope of the present invention as long as the cradle 106 prevents compromising or breaking the sealed contact between the face seal 100 and the face of the user when a hat is worn by same. Such any other full-face mask includes air-purifying respirators (APRs) and supplied-air respirators (SARs), and the like. It will further be appreciated that the face seal 100 may be retrofitted to the full-face mask 102 or any other full-face masks known in the art, including full-face mask respirators.

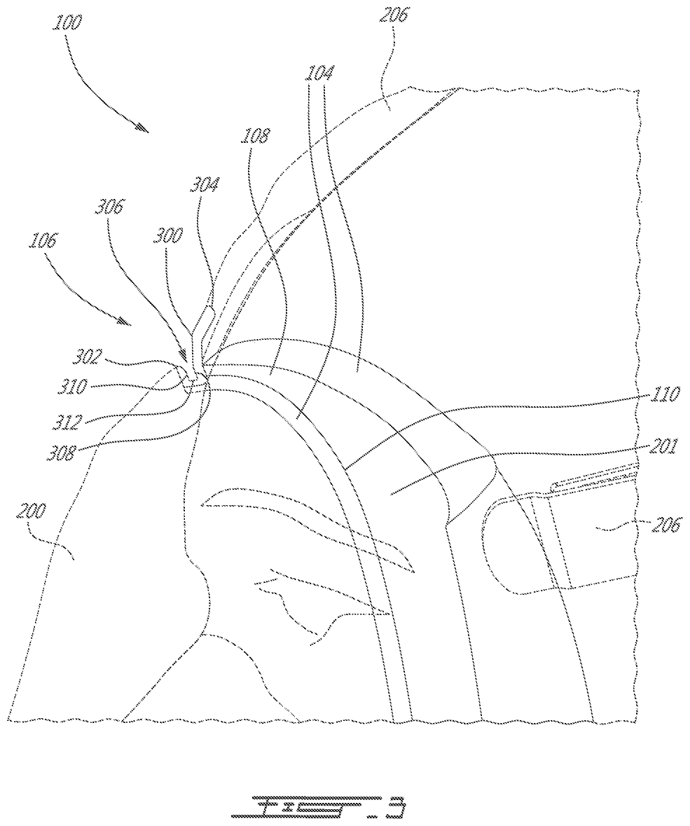

FIG. 3 illustrates an embodiment of the cradle 106 of the face seal 100. Located on the forehead portion 108 of the face seal 100 that contacts the forehead of the user, the cradle 106 may extend entirely along the peripheral portion 110 corresponding to the forehead portion 108 of the face seal 100 or may extend partially along the peripheral portion 110 corresponding to the forehead portion 108 of the face seal 100. In either configuration where the cradle 106 extends entirely or partially along the peripheral portion 110 corresponding to the forehead portion 108, the cradle 106 is capable of receiving at least a part of the head suspension harness 112 therein.

As it will become apparent hereinafter, the positioning of the cradle 106 on the forehead portion 108 of the face seal 100, and therefore on an uppermost portion of the full-face mask 102 to which the face seal 100 is installed, orientates and exposes upwardly the channel 306 of the cradle 106 for physical inter-engagement with the head suspension harness 112 of the hat 114.

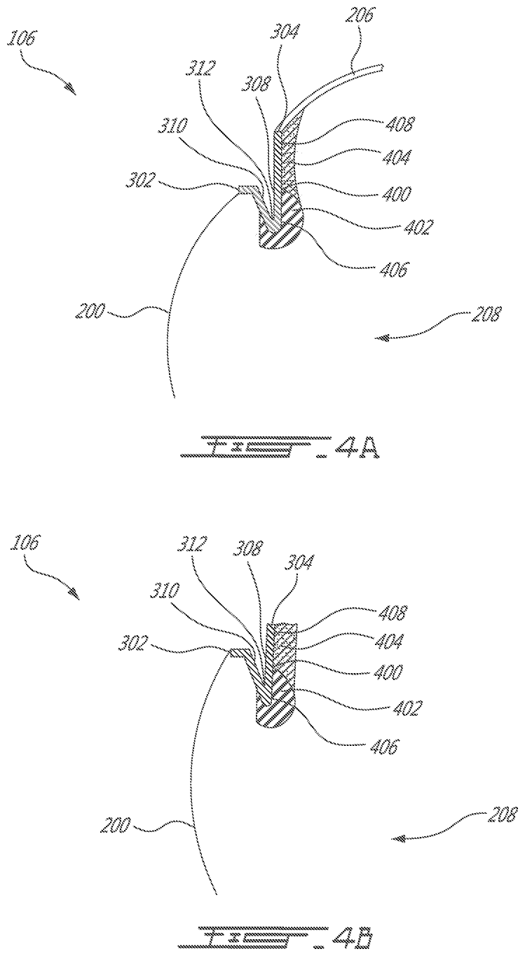

The cradle 106 generally has a curved or J-shaped body 300 when view in cross-section and extends between a first end 302 and a second end 304. When the face seal 100 is installed on the full-face mask 102, the first end 302 is located adjacent to the lens 200 of the full-face mask 102, and the second end 304 projects and bends away upwardly in relation to the first end 302. In such configuration, the second end 304 of the cradle 106 also projects and bents upwardly to generally conform to the contour of the face of the user. Adjacent to the first end 302, the J-shaped body 300 of the cradle 106 defines a channel 306, which may also be a groove, a notch, or any other structure capable of receiving the head suspension harness 112 therein. As illustrated in FIGS. 3 and 4A-B, the cradle 106 comprises a pair of longitudinally opposed walls 308 and 310 as well as an abutment wall 312 extending therebetween at the bottom of the channel 306. The pair of longitudinally opposed walls 308 and 310 as well as an abutment wall 312 are configured in size and shape to receive at least a part of the head suspension harness therein when the full-face mask 102 is worn together with the hat 114 by the user.

Particularly, as illustrated in FIG. 4A, at least one strap 206 used to attach the full-face mask 102 to the head of the user may project from the second end 304 of the cradle 106. For example, the cradle 106 may form a unitary body with at least one strap 206, such as by being integrally molded with a strap 206. Alternatively, as illustrated in FIG. 4B, no strap may project or may be molded with the cradle 106 so that the second end 304 of the cradle 106 projects freely away from the face seal 100 and full-face mask 102.

In an embodiment, the cradle 106 may form a unitary body with the sealing element 104 of the face seal 100. For example, the cradle 106 may be integrally molded with the sealing element 104 of face seal 100. In this case, the cradle 106 and the sealing element 104 of the face seal 100 may be made of a resiliently deformable material, including but not limited to polymer, elastomer, silicone, rubber, foam, and the like, that is adapted to form and maintain a sealed contact with at least a part of the face of the user. Alternatively, the cradle 106 may be rigid or substantially rigid and may be made of polymer, plastic, composite material, fiber(s) (e.g. fiberglass), metal (e.g. aluminum), metal alloy, and the like. In this case, the cradle 106 comprises a contact face 400 to contact the forehead of the user and at least one resiliently deformable element, such as the resiliently deformable element 402. The resiliently deformable element is disposed along the contact face 400 and is adapted to provide a sealed contact between the cradle 106 and the forehead of the user, as it will become apparent hereinafter.

In another embodiment, the cradle 106 may form a unitary body with the frame 201 of the full-face mask 102 or may be a stand-alone piece that is removably connectable to the frame 201 of the full-face-mask 102. In each configuration, the cradle is located on an uppermost portion of the full-face mask 102 that substantially correspond to the forehead portion 108 of the sealing element 104 of the face seal 100. Also, the cradle 106 may be rigid or substantially rigid in nature and, therefore, not made of a resiliently deformable material. For example, the cradle 106 may be made of polymer, plastic, composite material, fiber(s) (e.g. fiberglass), metal (e.g. aluminum), metal alloy, and the like. In configuration where the cradle 106 is forming a unitary body with the frame 201, the cradle 106 may be integrally molded with the frame 201 so that the face seal 100, when installed or mounted on the full-face mask 102, substantially conforms the contour of the cradle 106. In configuration where the cradle 106 is a stand-alone piece, the cradle 106 may be removably connectable not only to the frame 201, but also with the face seal 104. For example, the cradle 106 may be removably connected to any one of the frame 201 and the sealing element 104 by a snap-fit or interference fit, a quick release mechanism, a slidable engagement mechanism, and/or any other fastening or connecting mechanism know in the art.

FIGS. 4A-B illustrates an embodiment of the cradle 106 comprising a contact face 400 to contact the forehead of the user. The contact face 400 comprises two resiliently deformable elements 402 and 404. The first resiliently deformable element 402 is disposed on a first segment 406 of the contact face 400 corresponding to the channel 306 and is continuous with the sealing element 104 of the face seal 100. The second resiliently deformable element 404 is disposed on a second segment 408 of the contact face 400 that is adjacent to the second end 304 of the cradle 106 and is contiguous to the second resiliently deformable element 404. Also, the second resiliently deformable element 404 is located outwardly to the first resiliently deformable element 402 in relation to the face of the user.

In this configuration, the first resiliently deformable element 402 is adapted to sealingly contact the cradle 106 to at least a part of a forehead of the user, while the second resiliently deformable element 404 is adapted to provide an additional contact with the forehead of the user so as to reduce the overall pressure caused by the full-face mask 102 and the safety hat 114, respectively. This pressure reduction improves comfort for the user and therefore may increase user's resilience to wear the full-face mask 102 in combination with the safety hat 114.

The first resiliently deformable element 402 and the second resiliently deformable element 404 are made of resiliently deformable material, such as polymer, elastomer, silicon, rubber, foam, and the like. The density and/or deformable properties of the first resiliently deformable element 402 and the second resiliently deformable element 404 may vary in order to provide optimal sealing characteristics to the sealing element 104 and pressure reducing characteristics, respectively.

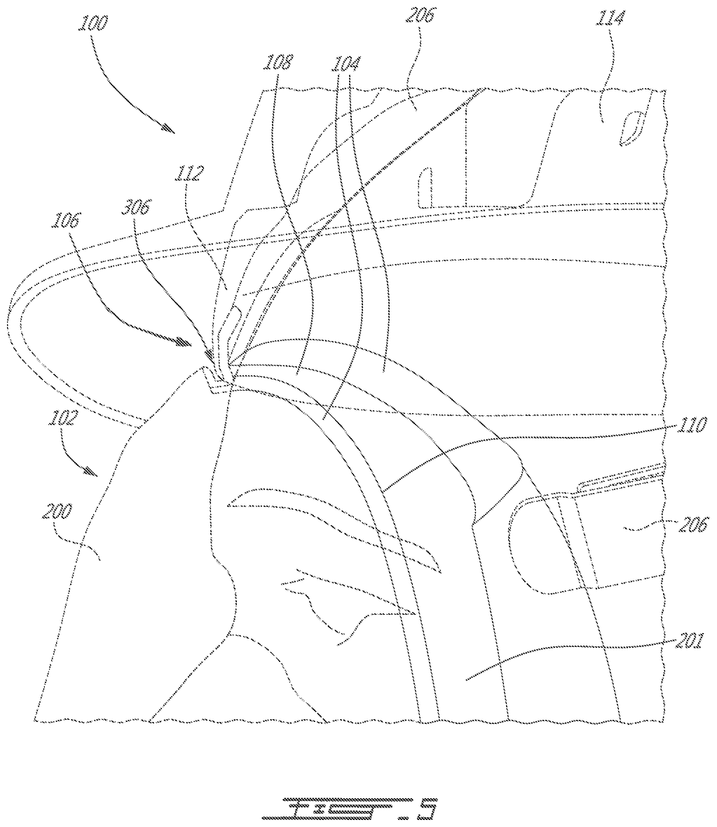

FIG. 5 illustrates the face seal 100 installed or mounted on the full-face mask 102 along with the hat 114, which are both worn by the user. As seen, the positioning of the cradle 106 on the forehead portion 108 of the face seal 100 directs the channel 306 of the cradle 106 upwardly toward the head suspension harness 112, which is received therein when the hat 114 is properly lodged on the head of the user. Accordingly, it will be appreciated that the cradle 106 provides the room required for the head suspension harness 112 of the hat 114 to properly engage the head of the user while the user wears the full-face mask 102. Hence, the hat 114 is lodged on the head of the user without interfering or hindering with the full-face mask 102 in a way that would compromise or break the sealed contact between the full-face mask 102 and the face of the user. In other word, the cradle 106 enables maintaining a sealed contact between the full-face mask 102 and the face of the user while the user wears the full-face mask 102 at the same time.

As such, the head suspension harness 112 may be fully received into the cradle 106 such that the head suspension harness 112 abuts to the longitudinally opposed walls 308 and 310 as well as an abutment wall 312 of the cavity 208. Alternatively, the head suspension harness 112 may be partially received into the cradle 106 such that there is an empty space between the longitudinally opposed walls 308 and 310 as well as an abutment wall 312 of the channel 306. Such empty space(s) may provide the clearance required for the hat 114 to move without inducing movement to the full-face mask 102 and may therefore be advantageous to maintain a proper sealed contact between the full-face mask 102 and the face of the user when the hat 114 receives a blow, a hit, a strike or the like.

In an embodiment, the head suspension harness 112 is received into the cradle 106 and is secured or fastener thereto by a snap fit or an interference fit mechanism, or any other securing or fastening mechanism known in the art. For example, the snap fit may made between the head suspension harness 112 and the longitudinally opposed walls 308 and 310. The securing or fastening of the full-face mask 102 with the hat 114 may be advantageous in providing a more solid, robust coupling between the full-face mask 102 and the hat 114.

When received into the cradle 106, the head suspension harness 112 may be snugly adjusted, such as by the use of a ratchet mechanism that reduces the diameter of the head suspension harness 112, in order for the head suspension harness 112 to mateably conform to the head of the user. In this case, the cradle 106 enables the hat 114 to be maintained in place on the head of the user so that the hat 114 may not be dislodged and fall on the ground when the user leans, for example, like it may happen with the hats and full-face masks known in the art.

While the head suspension harness 112 is received into the cradle 106, the skilled addressee will appreciate that any other components of the hat 114 that interferes or hinders with the full-face mask 102 may be received into the cradle 106 without departing from the scope of the present invention.

The embodiments of the invention described above are intended to be exemplary only. The scope of the invention is therefore intended to be limited solely by the scope of the appended claims.

1. A face seal for a full-face mask to be worn over a face of a user in combination with a hat comprising a head suspension harness, comprising:
a sealing element for sealingly contacting at least a part of the face of a user, the sealing element having a forehead portion and a peripheral portion; and
a cradle provided on the forehead portion, the cradle having a channel and an upward opening,
wherein the opening is sized and shaped for receiving the head suspension harness to lay down therein.

2. The face seal of claim 1, wherein the cradle is substantially rigid.

3. The face seal of claim 2, wherein the cradle comprises a first and a second resiliently deformable elements for contacting at least a part of a forehead of the user, the first resiliently deformable element being adapted for sealingly connecting the cradle to the at least a part of the forehead of the user, the second resiliently deformable element being adapted for connecting the cradle to the at least a part of a forehead of the user.

4. The face seal of claim 3, wherein any one of the first and second resiliently deformable elements is made of any one of polymer, elastomer, silicon, rubber, and foam.

5. The face seal of claim 1, wherein the hat is a security hat.

6. The face seal of claim 1, wherein the face seal is adapted to be retrofitted to a full-face mask.

7. A full-face mask to be worn over a face of a user in combination with a hat comprising a head suspension harness, comprising:
a body having a peripheral portion and a forehead portion extending along at least a part of the peripheral portion; and
a cradle provided on the forehead portion, the cradle having a channel extending sideways comprising an upward opening,
wherein the opening is sized and shaped for receiving the head suspension harness of a hat to lay down therein.

8. The full-face mask of claim 7, wherein the body comprises at least one of a frame and a lens.

9. The full-face mask of claim 7, wherein the cradle comprises a resiliently deformable element for contacting at least a part of a forehead of a user.

10. The full-face mask of claim 9, wherein the resiliently deformable element is made of any one of polymer, elastomer, silicon, rubber, and foam.

11. The full-face mask of claim 7, wherein the hat is a security hat.

12. A cradle for a full-face mask to be worn over a face of a user in combination with a hat comprising a head suspension harness, the cradle being connectable to a forehead portion of the full-face mask, the cradle comprising:
a channel extending sideways with an upward opening, wherein the channel extends along at least a portion of the forehead portion with the channel being sized and shaped for receiving a section of the head suspension harness to be laid down therein.

13. The cradle of claim 12, wherein the cradle comprises a resiliently deformable element for contacting at least a part of a forehead of a user.

14. The cradle of claim 13, wherein the resiliently deformable element is made of any one of polymer, elastomer, silicon, rubber, and foam.

15. The cradle of claim 12, wherein the hat is a security hat.

16. A full-face mask, comprising the face seal of claim 1.

17. The face seal of claim 3, wherein the second resiliently deformable element is further adapted for reducing the pressure between the cradle and the at least a part of a forehead of the user when a safety hat is worn by the user.

18. The cradle of claim 12, wherein the cradle is removably connectable to the forehead portion of the peripheral portion of the full-face mask.

19. The cradle of claim 13, wherein the resiliently deformable element is adapted for reducing the pressure between the cradle and the at least a part of a forehead of the user when a safety hat is worn by the user.

20. (canceled)

21. The cradle of claim 12, wherein the channel comprises a pair of opposed walls abutting opposite sides of the head suspension harness when laid down in the channel.
